(19) United States
(12) Patent Application Publication
(10) Pub. No.: US 2014/0336263 A1
(43) Pub. Date: Nov. 13, 2014

(54) ANIMAL DETERRENT SYSTEM AND METHODS THEREOF

(71) Applicant: Grizzly Mountain Enterprises LLC, Alexandria, MN (US)

(72) Inventors: Dean Krebs, Alexandria, MN (US); Shane Spencer, Star, ID (US)

(73) Assignee: Grizzly Mountain Enterprises LLC, Alexandria, MN (US)

(21) Appl. No.: 14/270,573

(22) Filed: May 6, 2014

Related U.S. Application Data
(60) Provisional application No. 61/820,377, filed on May 7, 2013.

(51) Int. Cl. A01M 29/10; A01N 35/06; A01M 29/12; A01N 37/18; A01M 29/00; A01M 29/16

(52) U.S. Cl. CPC A01M 29/10; A01M 29/00; A01M 29/16; A01M 29/12; A01N 37/18; A01N 35/06
USPC 514/627; 119/712; 119/719; 514/688

(57) ABSTRACT

An animal deterrent device that generally includes a casing, a sensor, a power source and a deterrent means source. The animal deterrent device is used to provide protection to a target site, such as a carcass or part of a carcass left at or near the kill site from predatory animals and/or scavengers. Other uses for the device include preventing animals from disrupting trash or garbage receptacles or for preventing animals from gaining access to campsite rations, food, a temporary carcass or parts of a carcass storage area, or trash.

### CLAIM OF PRIORITY

This application claims priority to provisional application No. 61/820,377 filed on May 7, 2013.

### BACKGROUND

Sportsmen who engage in hunting animals are routinely met with the dilemma of attempting to remove a large animal from the hunting grounds. This typically requires the division of the animal into at least two pieces to transport the downed animal from the kill site. This division is necessary because of the weight and the cumbersome shape of the downed animal. This division also may require the hunter making several trips to and from the kill site to remove the entire animal. This is especially true for sportsmen who hunt large animals, such as deer, elk, moose, bear, caribou, sheep, goats, bison, kudu, antelope, Water buffalo, Cape buffalo and the like.

When a sportsman leaves a portion of the field dressed carcass at the kill site, while the hunter returns a portion of the downed animal to a transport vehicle or campsite, the carcass left behind is susceptible to predatory animals and/or scavengers (i.e. bear, canines, felines, weasels, wolverines, martens, raccoons, skunks, badgers and the like). A field dress bag is typically used to prevent the downed animal meat from being contaminated by dirt and insect infestation. A hunter may not only lose a portion of the downed animal to scavengers, the hunter, returning to the kill site, may also be susceptible to predatory animals which are attracted to the downed animal and may be in the near proximity to the kill site. When a sportsman returns to a carcass or kill site, there is a major safety concern with not knowing if a large predator has claimed the kill and is guarding the site. There is no current mechanism of protecting the downed animal meat left at the kill site which can also be used to deter scavengers from remaining in close proximity to the kill site.

### SUMMARY

In one example embodiment described herein, a device is described that enables the protection of a carcass left at the kill site from predatory animals and/or scavengers. In other related embodiments, the device aids in preventing animals from disrupting trash or garbage receptacles or preventing animals from gaining access to meat storage, campsite rations or food.

### BRIEF DESCRIPTION OF THE DRAWINGS

FIG. 1 illustrates a perspective view of an animal deterrent device.

FIG. 2 is a side elevation view of an animal deterrent device.

FIG. 3 is a side elevation view of the interior compartment of an animal deterrent device.

FIG. 4 illustrates a perspective view of a securement means for an animal deterrent device.

FIG. 5 is a bottom perspective view of the bottom portion of casing of an animal deterrent device.

FIG. 6 is top perspective view of the base mount of an animal deterrent device.

FIG. 7 illustrates a side elevation view of a control panel of an animal deterrent device.

FIG. 8 is a top perspective view of a remote control for communication with an animal deterrent device.

FIG. 9 illustrates a top perspective view of an alternative embodiment of an animal deterrent device.

FIG. 10 illustrates a side elevation view of the animal deterrent device of FIG. 9.

### DESCRIPTION OF THE PREFERRED EMBODIMENTS

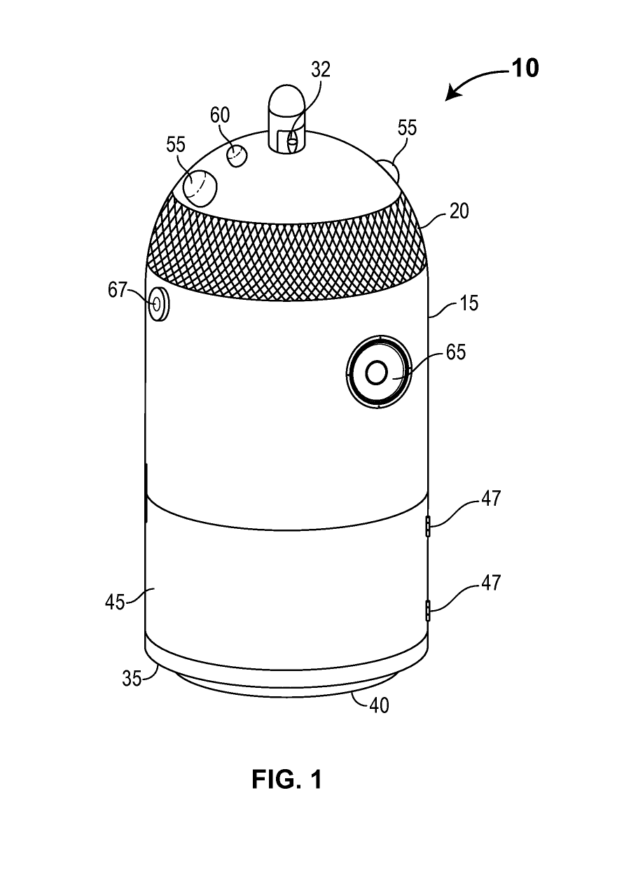

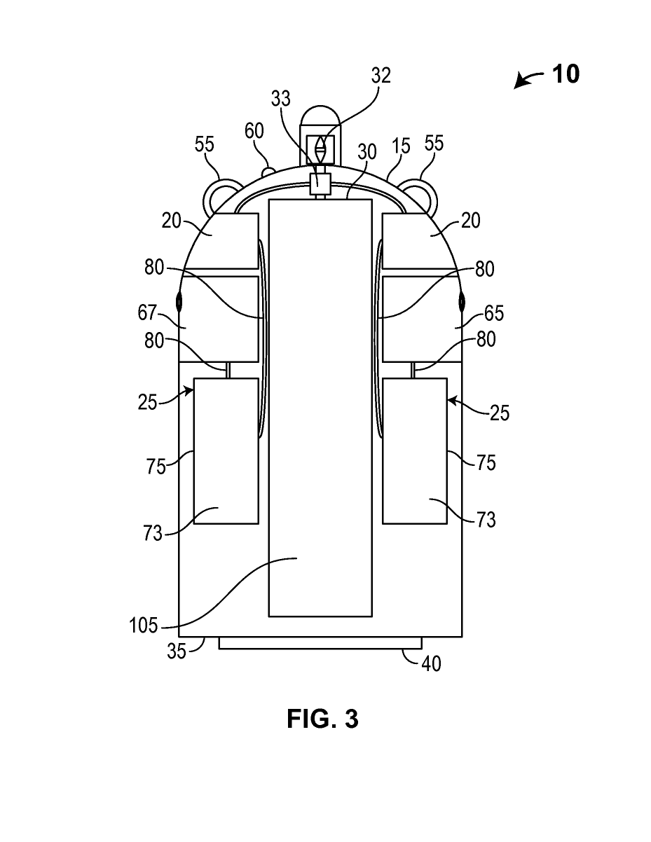

Referring now to the drawings, wherein like reference numerals designate identical or corresponding parts throughout the several views, as shown in FIGS. 1-3, an animal deterrent device 10 generally includes a casing 15, a sensor 20, a power source 25 and a deterrent means source 30 (shown in FIG. 3).

Casing 15 may be generally cylindrical in shape and include, for example, a base mount 40, which may act as a support for animal deterrent device 10. Although casing 15 is depicted with a cylindrical shape, other shapes and configurations are contemplated. Casing 15 is preferably made of a durable material such as metal or plastic. In embodiments where casing 15 is metal, a rust-resistant metal is preferred, such as stainless steel or aluminum. In embodiments where a rust-resistant metal is not utilized, the metal may be covered with a waterproof coating or made of plastic. Casing 15 is also substantially watertight to prevent moisture from damaging the internal components of animal deterrent device 10.

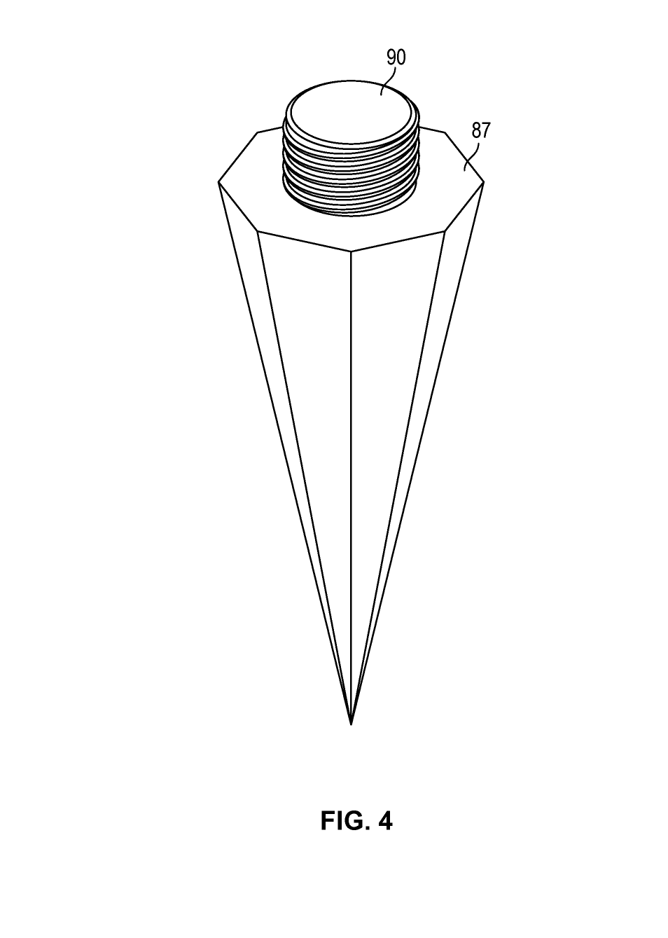

Bottom portion 35 may be transparent, translucent or opaque, depending on the material and design of the external surface of casing 15. In embodiments where bottom portion 35 is removable, bottom portion 35 will generally include a plurality of threads along the outer circumference to facilitate unscrewing bottom portion 35 from casing 15. It should be appreciated that bottom portion 35 may also include a rubber gasket or washer (not shown) along the outer circumference, or along the top surface periphery, to further seal the internal cavity of casing 15. Similarly, receiving chamber 70 may also include threads to allow for accessories, to be securely fastened to bottom portion 35, or base mount 40. One such accessory is a stake 87, as shown in FIG. 4. Stake 87 may be made of a durable, rigid material that allows the apparatus to be securely positioned in the ground or to the carcass itself.

Base mount 40 is connected to bottom portion 35 of casing 15, which allows for base mount 40 to be securely coupled to casing 15. It should be appreciated that bottom portion 35 may be a separate piece that can be removed from casing 15. Alternatively, bottom portion 35 may be a part of a singular unitary body of casing 15. In this embodiment, casing will include an opening (not shown) allowing access to the internal compartment of animal deterrent device 10.

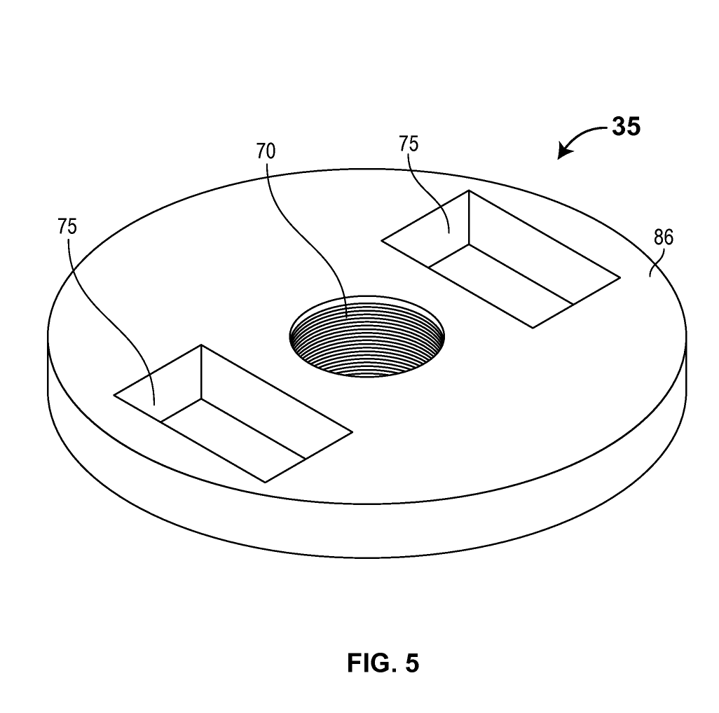

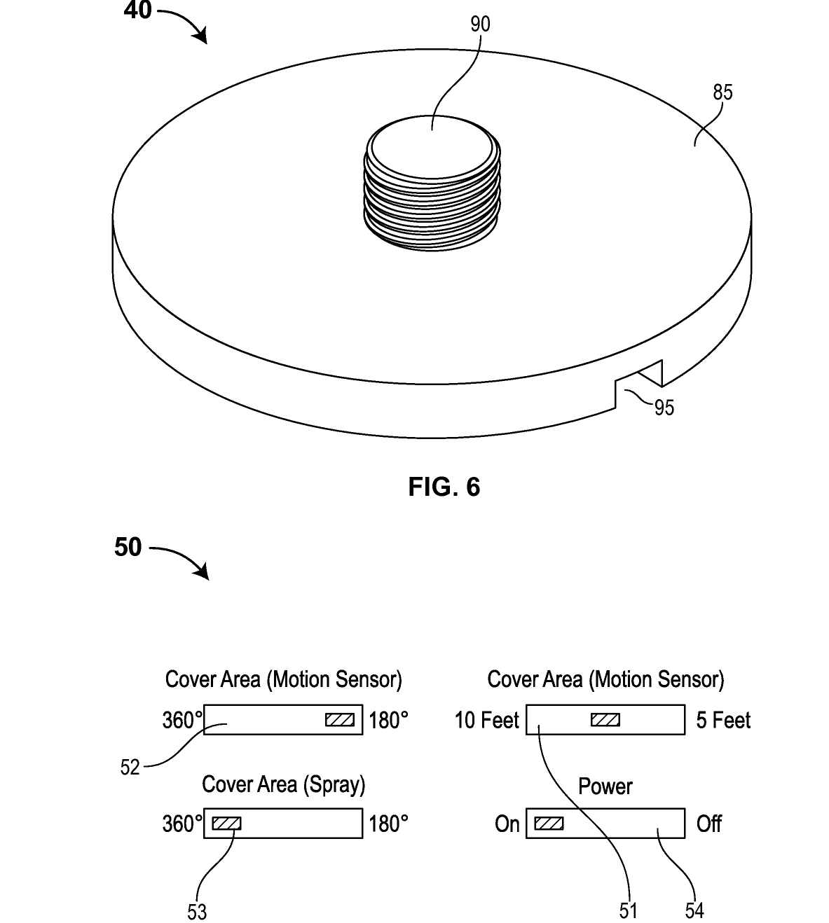

In one example embodiment, animal deterrent device 10 includes a base mount 40 that is attached to bottom portion 35. As shown in FIG. 6, base mount 40 is generally shaped and sized similar to bottom portion 35 of casing. The inner surface 85 of base mount 40 may include a protruding member 90 that may allow for attachment to bottom portion 35. Although not shown, the outer surface of base mount may also include a receiving means to attach other accessories, such as a stake, hook, and the like. Base mount 40 may further comprise a magnet, to allow for securement to a metal object, such as the lid to a trash receptacle. Base mount 40 may also include a channel 95 which can be used to tighten base mount 40 onto bottom portion 35 with a tool, such as a screwdriver.

Referring now to FIG. 7, which illustrates one example of a control panel 50 that may include a number of features desired for deterring predatory animals and scavengers from a protected target. FIG. 7 illustrates a number of non-exclusive features that may be included: cover area (motion sensor) 51 which will set the distance for the deterrent means to be activated; cover area (motion sensor) 52 which will allow the user to select various detection ranges for the motion sensor in relation to the animal deterrent device 10, two such settings include 360° and 180°; cover area (spray) 53 which will be used to select various spray patterns for the motion sensor in relation to the animal deterrent device 10, two such settings include 360° and 180° spray patterns; and power 54 with a designated on and off switch.

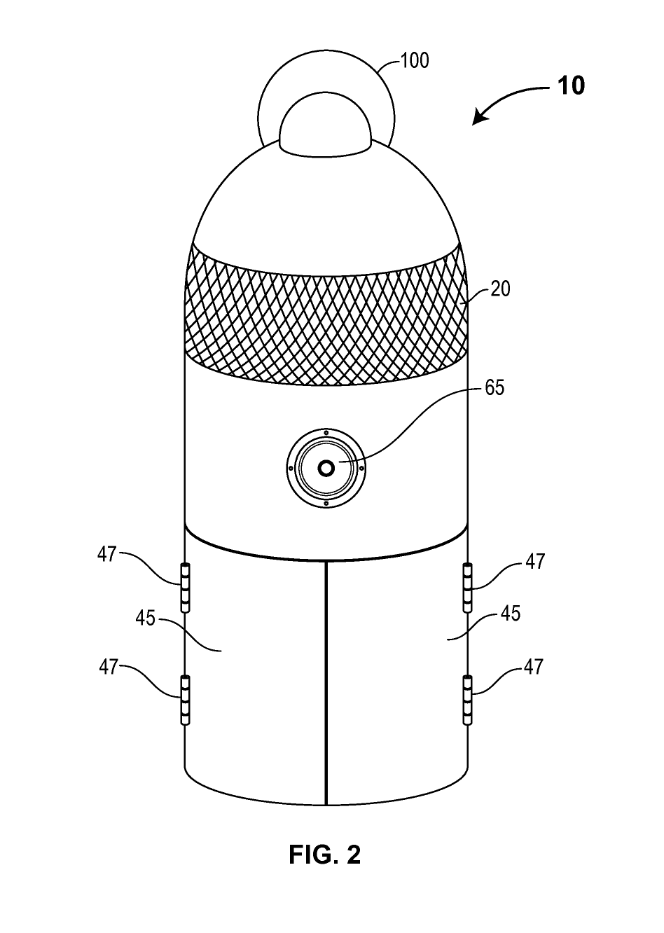

In a related embodiment, animal deterrent device 10 includes a hook 100, as shown in FIG. 2. Hook 100 is shaped to allow a string, cord, wire, lanyard or karabiner to be attached to allow animal deterrent device 10 to be hung, for example, above a carcass. Hook 100 may also make transport easier as animal deterrent device 10 could be readily attached to a backpack, belt or gun strap. Hook 100 may be permanently fixed to the casing or may be removable. In one example embodiment, hook 100 is removed during use, to prevent hook 100 from interfering with the nozzle 32, which can spray a substance from deterrent means source 30 via a valve 33.

Casing 15 also may include a control panel cover 45 which allows the user access to control panel 50 (see FIG. 7). Control panel cover 45 may be attached to casing 15 in a number of ways, including but not limited to a hinge 47. Control panel cover 45 may also include a seal along the edge which provides an additional protection from moisture and environmental conditions. One such sealing mechanism includes a rubber gasket. Control panel cover 45 may include several configurations, such as but not limited to a single-door configuration, as shown in FIG. 1. In a related embodiment, control panel cover 45 includes a two-door configuration, as shown in FIG. 2.

As best shown in FIGS. 1 and 3, casing 15 may include an alarm indicator 55 and/or a status indicator 60. Status indicator 60 may be utilized to provide the user or a person walking nearby notification that animal deterrent device 10 is activated (i.e. armed). Alarm indicator 55 should be readily visible, in at least one embodiment, alarm indicator is a LED. Although not wanting to be bound by any particular theory, status indicator 60 may utilize several different types of mechanisms to indicate that the animal deterrent device 10 is “armed,” such as a rapidly blinking light. Status indicator 60 may also show the status of animal deterrent device 10, such as, low battery or deterrent means contents is low. Similarly, alarm indicator 55 may also utilize other light sources, know to one skilled in the art. The alarm indicator 55 shows, via a highly visible flashing light, that the motion sensor has been triggered.

As shown in FIG. 3, casing 15 may also include an internal area which may generally include a power source (i.e. battery pack) 25, circuitry 80, valve 33 and deterrent means source 30. Casing 15 may optionally include an area for a camera and/or a speaker. In a related embodiment, animal deterrent device 10 will include wireless capabilities to send information, such as animal deterrent device 10 has been triggered. This message can be sent to a user's phone, email or remote control. Circuitry 80 may include both electrical and fluid communication means; wires, hoses and the like, which connect the several internal components of animal deterrent device 10.

Valve 33 is normally in a closed position and in communication with deterrent means source 30, motion sensor 20 and nozzle 32. When valve 33 is activated by a signal from motion sensor 20, the pressurized contents of deterrent means source 30 are released through the open valve 33. Once a predetermined amount of time has elapsed and/or a predetermined amount of deterrent means is released, valve 33, will close. Valve 33 may comprise a single valve arrangement; however, a two-way or three-way valve may also be utilized. Valve 33 that provides for 180 degree and/or 360 degree spray without the need for a specialized nozzle is within the purview of the invention.

In another related embodiment, valve 33 may be connected to nozzle 32, which can rotate upon activation by motion sensor 20, thereby covering a preselected radius. In another related embodiment, deterrent means source 30, may rotate when valve 33 is activated by motion sensor 20, thereby covering a preselected radius.

Power source 25 may include a number of known sources of energy, such as solar power, battery power or electrical power. Referring to FIGS. 3 and 5, one power source is a battery 73 which is located in battery insert 75, which is capable of housing batteries such as a 6V lantern battery. A battery to provide sufficient energy (i.e. 9V, D, C or AA) to allow the various features of animal deterrent system to operate is within the scope of the present invention.

Battery insert 75 may further include clasps (not shown) to securely support battery 73. As shown in FIG. 5, battery insert 75 is at least partially disposed in bottom portion 35 and may be accessible along outer surface 86. In a related embodiment, FIG. 3 depicts battery insert 75 being substantially positioned within the internal cavity of casing 15. Battery insert 75 is connected via circuitry to the various internal components of animal deterrent device, such as camera 67, speaker 65, motion sensor 20, status indicator 60, alarm indicator 55 and deterrent means source 30.

Referring now to FIG. 3, the internal cavity of casing 15 may comprise a substantial portion of motion sensor 20. Motion sensor 20 provides at least one perimeter around animal deterrent device 10. In at least one example embodiment, motion sensor 20 can be in communication with control panel 50 to provide a specific distance at which alarm indicator 55 will activate. As best shown in FIG. 3, motion sensor 20 may also be in communication with the deterrent means source 30 via valve 33. If motion sensor 20 is activated, both lighted alarm indicator 55 and deterrent means source 30 will simultaneously be triggered. In at least this embodiment, an optional speaker 65 may be utilized to provide an audible warning which is simultaneously activated by motion sensor 20.

In another example embodiment, deterrent means source 30 is programmed to activate at a predetermined distance that is closer to animal deterrent device 10 then the distance which activates alarm indicator 55. This dual sensing mechanism allows for animal deterrent device 10 to give adequate warning to other sportsmen in the vicinity. Conversely, predatory animals or scavengers may continue to move towards animal deterrent device 10, which will activate once the predatory animal or scavenger comes too close to animal deterrent device 10.

Motion sensor 20 may optionally be connected to speaker 65 to provide an audible warning in conjunction with alarm indicator. Speaker 65 may be used to provide an insulting sound to scare the predator away. Speaker 65 may also provide an intermittent beep to alert the owner that the device has been triggered since the owner left the device, this will give the hunter adequate notice that a predatory animal or scavenger has been in the near vicinity since the animal deterrent device 10 was turned on, thus providing an added warning mechanism for the hunter, sportsman or camper. Speaker 65 may also provide audible indications in relation to the status of animal deterrent device 10, such as “armed” or “low battery.”

Deterrent means source 30 may include a number of ways to prevent a predatory animal or scavenger from coming within the perimeter of a target zone. In one example embodiment, as shown in FIG. 3, the deterrent means source 30 is a spray cartridge 105. Spray cartridge 105 (or canister) may be replaceable or refillable. The deterrent means is pressurized within spray cartridge 105 and may include compositions such as pepper spray, mace, water and the like.

In other related embodiments, the composition may be an odorized repellant. In other related embodiments the deterrent means may include sound, or a flashing light. The device may provide either one or multiple spray events from each triggering episode. In other words, if motion sensor 20 is triggered, animal deterrent device 10 may provide a single spray, however, if the predatory animal remains within the target perimeter multiple sprays may occur. In related embodiments, motion sensor 20, may also trigger deterrent means to spray in multiple shot cadences until the predatory animal has left the target zone. In another related embodiment, motion sensor 20, will locate a predatory animal or scavenger, thereby causing the deterrent means to be sprayed in the direction of the approaching animal. This targeted approach could be utilized to reduce amounts of deterrent means, thus making a much more economical use of deterrent means.

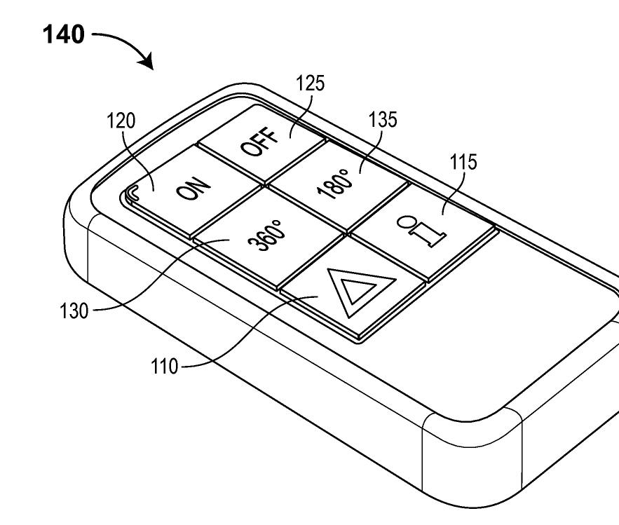

Referring now to FIG. 8, which illustrates a remote control 140 that can be used to activate/inactivate various features on animal deterrent device 10. In one example embodiment, remote control 140 includes an on button 120, off button 125, 360 degree button 130 (for spray and/or motion sensor), 180 degree (for spray and/or motion sensor) 135, an emergency stop button 110 and an information button 115. Although the various buttons depicted are considered advantageous, any number of features and buttons, to best provide a remote form of communication with animal deterrent device 10 are within the scope of the invention.

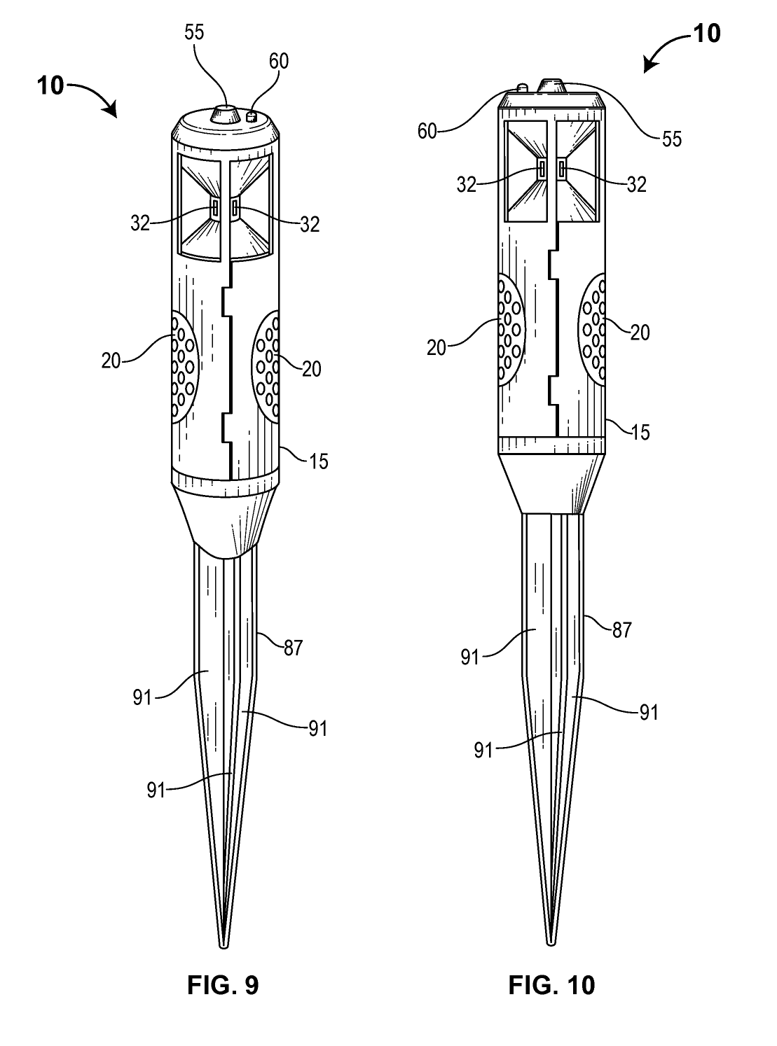

Referring now to FIGS. 9 and 10 which illustrate an alternative embodiment of animal deterrent device 10 which generally includes a casing 15, a sensor 20, a power source (not shown) and a deterrent means source (not shown). In at least this embodiment, casing 15 may include an alarm indicator 55 and/or a status indicator 60. In this example embodiment, alarm indicator 55 and status indicator 60 are positioned along the top surface of casing 15. As previously described above, status indicator 60 may be utilized to provide the user or a person walking nearby notification that animal deterrent device 10 is activated (i.e. armed). Similarly, alarm indicator 55 should also be readily visible, although the precise position on animal deterrent device 10 would be known to one of ordinary skill in the art based on the particular purpose and function. As previously mentioned, stake 87 may be made of a durable, rigid material that allows the apparatus to be securely positioned in the ground or to the carcass itself. Stake 87 may further include flange 91 to help securely position animal deterrent device 10 in a substrate, such as the ground or a downed animal. Flange 91 may also improve the methods and processes of making stake 87. It should be appreciated that stake 87 may be permanently coupled, removeably coupled or a portion of a single casing 15 design.

Still referring to FIGS. 9 and 10, valve (not shown) is positioned in the internal cavity of casing 15 and connected to nozzle 32, which can rotate upon activation by motion sensor 20, thereby covering a preselected radius. As shown, nozzle 32 is comprised of two apertures for spraying a deterrent means when activated by motion sensor 20, thereby covering a preselected radius.

When in use animal deterrent device 10 may be used in a number of situations. In one example embodiment, animal deterrent device 10 is placed near the parts of the carcass meant to be protected, for example remaining meat sections. The deterrent means is under pressure until motion sensor 20 is triggered and valve 33 opens for a pre-determined time period blasting pepper spray towards the predatory animal or scavenger. Although not wanting to be bound by any particular theory, animal deterrent means source would have sufficient volume to provide about 1-3 sprays before the volume of spray is exhausted. Although various sized canisters and cartridges to provide for about 1-10 sprays before the volume of spray is exhausted are also contemplated.

Other uses for the device include preventing animals from disrupting trash or garbage receptacles, such as the ones used in state and federal parks or campgrounds. Other uses for the device include preventing animals from gaining access to campsite rations or food or waste (garbage) piles. Another use for the device includes protecting carcasses or parts of carcasses at a storage location near the campsite.

While the present invention has been disclosed with reference to particular details of construction, these should be understood as having been provided by way of example and not as limitations to the scope or spirit of the invention. Various embodiments of the invention have been described above for purposes of illustrating the details thereof and to enable one of ordinary skill in the art to make and use the invention. The details and features of the disclosed embodiment[s] are not intended to be limiting, as many variations and modifications will be readily apparent to those of skill in the art. Accordingly, the scope of the present disclosure is intended to be interpreted broadly and to include all variations and modifications coming within the scope and spirit of the appended claims and their legal equivalents.

1. An animal deterrent device comprising:
a casing;
a sensor mechanism;
a deterrent means source; and
a power source operatively coupled to said sensor mechanism and said deterrent means source
wherein at least a portion of said power source and said deterrent means source are contained within said casing and wherein said sensor being in communication with said deterrent means source.

2. An animal deterrent device of claim 1, wherein the animal deterrent means further comprises a bottom portion being removable from said casing.

3. An animal deterrent device of claim 2, wherein said base mount comprises a magnet.

4. An animal deterrent device of claim 1, wherein the animal deterrent device further comprises a valve, wherein the valve being in communication with said deterrent means source, said valve is in a closed position until activated, wherein said valve upon activation will open to release the contents of said deterrent means source.

5. An animal deterrent device of claim 1, wherein the animal deterrent device further comprises a base mount.

6. An animal deterrent device of claim 1, wherein the animal deterrent device further comprises a control panel.

7. An animal deterrent device of claim 1, wherein the animal deterrent device further comprises a speaker.

8. An animal deterrent device of claim 1, wherein the animal deterrent device further comprises an alarm indicator.

9. An animal deterrent device of claim 1, wherein the deterrent means source is selected from a group consisting of a canister, a cartridge, a speaker, a diode and a bulb.

10. An animal deterrent device of claim 8, wherein the animal deterrent device emits an animal deterrent selected from a group consisting of pepper spray, mace, water, odorized repellant, sound and light.

11. An animal deterrent device of claim 1, wherein the animal deterrent means further comprises a status indicator.

12. A method of deterring an animal comprising:
Placing an animal deterrent device as substantially described in claim 1 around a target site.

13. A method of deterring an animal of claim 12, wherein said target site is a downed animal.

14. A method of deterring an animal of claim 12, wherein said target site is a portion of an animal carcass.

15. A method of deterring an animal of claim 12, wherein said target site is selected from a group consisting of a meat storage area, a food supply container and a campsite.

16. A method of deterring an animal of claim 12, wherein said target site is selected from a group consisting of a trash receptacle, garbage can, a dumpster and trash pile.
